(19) United States
(12) Patent Application Publication
(10) Pub. No.: US 2019/0147167 A1
(43) Pub. Date: May 16, 2019

(54) APPARATUS FOR COLLECTING VULNERABILITY INFORMATION AND METHOD THEREOF

(71) Applicant: KOREA INTERNET & SECURITY AGENCY, Naju-si (KR)

(72) Inventors: Hwan Kuk KIM, Naju-si (KR); Tae Eun KIM, Naju-si (KR); Dae Il JANG, Naju-si (KR); Chang Hun YU, Naju-si (KR); Yong Nam SON, Naju-si (KR); Eun Hye KO, Naju-si (KR); Sa Rang NA, Naju-si (KR)

(73) Assignee: KOREA INTERNET & SECURITY AGENCY, Naju-si (KR)

(21) Appl. No.: 15/876,514

(22) Filed: Jan. 22, 2018

(30) Foreign Application Priority Data
Nov. 15, 2017 (KR) 10-2017-0152291

(51) Int. Cl. G06F 21/57; G06F 8/41; H04L 29/06; G06F 17/30; G06F 17/27

(52) U.S. Cl. CPC G06F 21/577; G06F 8/427; G06F 17/2705; G06F 17/30625; H04L 63/1433

(57) ABSTRACT

There are provided an apparatus for collecting vulnerability information of a computer system and a method thereof. The method includes: downloading a vulnerability file including formal vulnerability data configured in a predetermined format from a vulnerability database; classify the formal vulnerability data by performing file parsing for the vulnerability file on the basis of the predetermined format ; classify informal vulnerability data included in the source code by performing source code parsing for a source code of a web page and formalizing the informal vulnerability data on the basis of a result of the classification; and storing the formal vulnerability data and the formalized informal vulnerability data in a field of a vulnerability table on the basis of a result of the classification.

This application claims priority from Korean Patent Application No. 10-2017-0152291, filed on Nov. 15, 2017, in the Korean Intellectual Property Office, the disclosure of which is incorporated herein by reference in its entirety.

### BACKGROUND

### 1. Field of the Invention

The present invention relates to an apparatus for collecting vulnerability information and a method thereof.

### 2. Description of the Related Art

The contents described herein merely provide background information on this embodiment, but do not describe a known art.

Security vulnerabilities provided in software can be easily misapplied to attack computer systems. Attackers can perform malicious actions by indentifying security-vulnerable web services with internet scanning tools. Therefore, security administrators are required to examine open vulnerabilities and quickly respond thereto. In particular, recently, the number of devices connected to the internet has increased with the wide spread of IoT (Internet of Things) appliances. Therefore, it is required to quickly examine the security vulnerabilities of a large number of computer systems connected to the internet and analyze these security vulnerabilities. Vulnerability analysis refers to determining a method of responding to security incidents by identifying and analyzing vulnerabilities in order to prevent the security incidents caused by security vulnerabilities in advance.

The National Vulnerability Database (NVD) provides common vulnerabilities and exposures (CVE) information to easily share known security vulnerability information in advance. The CVE information includes a vulnerability identifier (common vulnerabilities and exposures identifier (CVE-ID)), a vulnerability overview, a vulnerability score (common vulnerability scoring system (CVSS)), a vulnerable product name (common platform enumeration (CPE)), and a vulnerability kind (common weakness enumeration (CWE)). The CVE information is provided as an XML file or the like according to a predetermined format.

In addition to the CVE information provided from the NVD, information about security vulnerabilities of devices connected to the internet in various forms is provided. For example, makers of IoT devices, providers of arbitrary vulnerability information, or providers of operating systems publish vulnerability information about IoT devices and software on their Web pages. However, the vulnerability information provided by various providers is not fixed in many cases. Therefore, there is a problem that it is difficult to collectively collect and manage vulnerability information that is not fixed in form, other than the vulnerability information provided in fixed form data. Further, there is a problem that it is difficult to collectively analyze more vulnerability information when analyzing the collected vulnerability information, due to the lack of integration of the vulnerability information.

### SUMMARY

An aspect of the present invention is to provide an apparatus and method for collecting formal vulnerability data and informal vulnerability data and integrating and storing the collected formal vulnerability data and informal vulnerability data.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the inventive concept, there is provided a method of collecting vulnerability information comprises downloading a vulnerability file including formal vulnerability data configured in a predetermined format from a vulnerability database; classifying the formal vulnerability data by performing file parsing for the vulnerability file on the basis of the predetermined format; classify informal vulnerability data included in the source code by performing source code parsing for a source code of a web page and formalizing the informal vulnerability data on the basis of a result of the classification; and storing the formal vulnerability data and the formalized informal vulnerability data in a field of a vulnerability table on the basis of a result of the classification.

According to another aspect of the inventive concept, the field includes a product name field, the classifying the informal vulnerability data includes extracting a product name from a text included in the web page, the formalizing the informal vulnerability data includes converting the product name in a CPE (Common Platform Enumeration) format, and the storing the formal vulnerability data and the formalized informal vulnerability data includes storing the converted product name in the product name field.

According to another aspect of the inventive concept, the storing the converted product name includes searching a CPE value corresponding to the product name converted in the CPE format for the formal vulnerability data, searching common vulnerabilities and exposures (CVE) information corresponding to the CPE value from the formal vulnerability data and including the CVE information in the vulnerability table.

According to another aspect of the inventive concept, the converting the product name comprises acquiring a CPE dictionary, generating a CPE tree having a plurality of levels and a plurality of nodes by analyzing the CPE dictionary, searching keywords of each level of the CPE tree from the converted product name and outputting a CPE conforming to the format of the CPE dictionary from the CPE tree by combining keywords included in the converted product name among the keywords of the CPE tree.

According to another aspect of the inventive concept, the formalizing the informal vulnerability data includes extracting a vulnerability value and a vulnerability vector from the informal vulnerability data and converting the vulnerability value and the vulnerability vector in a common vulnerability scoring system (CVSS) format.

According to another aspect of the inventive concept, the formalized informal vulnerability data is obtained by combining the vulnerability value and the vulnerability vector.

According to another aspect of the inventive concept, the classifying the informal vulnerability data includes inputting the source code into a text classification model and acquiring the formalized informal vulnerability data on the basis of output of the text classification model.

According to another aspect of the inventive concept, the classifying the informal vulnerability data further includes extracting features from the formal vulnerability data and generating the machine learning-based text classification model on the basis of the extracted features.

According to another aspect of the inventive concept, the extracting the features includes extracting a vulnerability overview text and a vulnerability classification code (common weakness enumeration (CWE)) and extracting features from the vulnerability overview text, and wherein the generating the text classification model includes generating the text classification model so as to output the vulnerability classification code when a text corresponding to the features is input into the text classification model.

According to another aspect of the inventive concept, the field includes a vulnerability identifier field, a title field, a vulnerability overview field, a vulnerable product name field, a vulnerability score field, and a vulnerability kind field.

According to another aspect of the inventive concept, wherein the formal vulnerability data includes CVE-ID(Common Vulnerability and Exposure-Identifier), CPE, and CWE, and the storing the formal vulnerability data includes storing the CVE-ID in the vulnerability identifier field, storing the CPE in the vulnerable product name field, and storing the CWE in the vulnerability kind field.

According to another aspect of the inventive concept, wherein the formalizing the informal vulnerability data includes determining a manufacturer name, a product name, a version, and vulnerability classification from the text and determining a title combined with the manufacturer name, the product name, the version, and the vulnerability classification, wherein the storing the formal vulnerability data includes storing the title in the title field of the vulnerability table.

According to an aspect of the inventive concept, there is provided an apparatus for collecting vulnerability information that comprises an information collector for downloading a vulnerability file including formal vulnerability data configured in a predetermined format from a vulnerability database and acquiring a source code of a web page; an information processor for classifying the formal vulnerability data by performing file parsing for the vulnerability file, classifying informal vulnerability data included in the source code by performing source code parsing for a source code of a web page, and executing an operation of formalizing the classified informal vulnerability data in the predetermined format; and a storage medium for storing the formal vulnerability data and the formalized informal vulnerability data in a field of a vulnerability table on the basis of a result of the classification.

According to an aspect of the inventive concept, there is provided a computer program, which is recorded in a non-transitory computer-readable medium, and which performs an operation when commands of the computer program are executed by a processor of a server, the operation comprises downloading a vulnerability file including formal vulnerability data configured in a predetermined format from a vulnerability database; classifying the formal vulnerability data by performing file parsing for the vulnerability file; classifying informal vulnerability data included in the source code by performing source code parsing for a source code of a web page and formalizing the informal vulnerability data on the basis of a result of the classification; and storing the formal vulnerability data and the formalized informal vulnerability data in a field of a vulnerability table on the basis of a result of the classification.

### BRIEF DESCRIPTION OF THE DRAWINGS

The above and other aspects and features of the present invention will become more apparent by describing in detail exemplary embodiments thereof with reference to the attached drawings, in which:

FIGS. 1 and 2 are views illustrating examples of formal vulnerability data configured in a spreadsheet file format;

FIG. 3 is a view illustrating an example of informal vulnerability data provided in the form of a web page;

FIG. 4 is a diagram illustrating a structure of a vulnerability information collecting apparatus according to an embodiment;

FIG. 5 is a diagram illustrating a process of collecting vulnerability information according to an embodiment;

FIG. 6 is a diagram illustrating a concept of a method of classifying vulnerability data for each vulnerability data source according to an embodiment;

FIG. 7 is a diagram illustrating a concept of a method of classifying formal vulnerability data according to an embodiment;

FIGS. 8 and 9 are diagrams illustrating concepts of a method of classifying informal vulnerability data according to an embodiment;

FIG. 10 is a diagram illustrating a concept of a method of converting a product name into a CPE format by vulnerability information collecting apparatus according to an embodiment; and

FIG. 11 is a view illustrating an example of vulnerability information stored in a field of a vulnerability table for each vulnerability information source according to an embodiment.

### DETAILED DESCRIPTION OF THE EMBODIMENTS

Hereinafter, preferred embodiments of the present invention will be described with reference to the attached drawings. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like numbers refer to like elements throughout.

Unless otherwise defined, all terms including technical and scientific terms used herein have the same meaning as commonly understood by one of ordinary skill in the art to which this invention belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Throughout the specification, vulnerability information refers to information capable of identifying a product having known security vulnerabilities and known security vulnerabilities for the product such that it can be used to refer to security vulnerabilities such as software packages. For example, vulnerability information may include product names of vulnerable products, overview of vulnerabilities, titles of vulnerabilities, kinds of vulnerabilities, scores of vulnerabilities, vulnerability identifiers that are codes capable of identifying vulnerabilities, reference information related to vulnerability information, released dates, remote/local information, and solutions. However, the present invention is not limited thereto.

Throughout the specification, vulnerability data refers to data including vulnerability information. Vulnerability data may be configured in various formats. Vulnerability data may be configured in the form of a file, or may be configured in the form of a source code of a web page.

Further, throughout the specification, formal vulnerability data refers to data representing vulnerability information in a fixed form. For example, NVD provides CVE information in the form of an XML file. CVE information may include items of CVE-ID, Overview, CVSS, CPE, and CWE in a fixed form. Further, items such as CVE-ID, CVSS, CPE, and CWE are configured in a predetermined form. For example, CVE-ID is an identifier for indentifying each CVE information, and is configured in the form of ‘CVE-(4 digits)-(4 digits)’. CVSS may be configured in the form of ‘(decimal between 0.0 and 10.0)+(vector matrix)’. CWE may be configured in a form including a code (digit) representing the kind of vulnerabilities. In contrast, informal vulnerability data refers to data in which vulnerability information is not fixed.

Throughout the specification, the vulnerability table means that vulnerability information is stored in the form of a structured table.

Throughout the specification, vulnerability data includes formal vulnerability data and informal vulnerability data.

Hereinafter, embodiments of the present invention will be described with reference to the attached drawings.

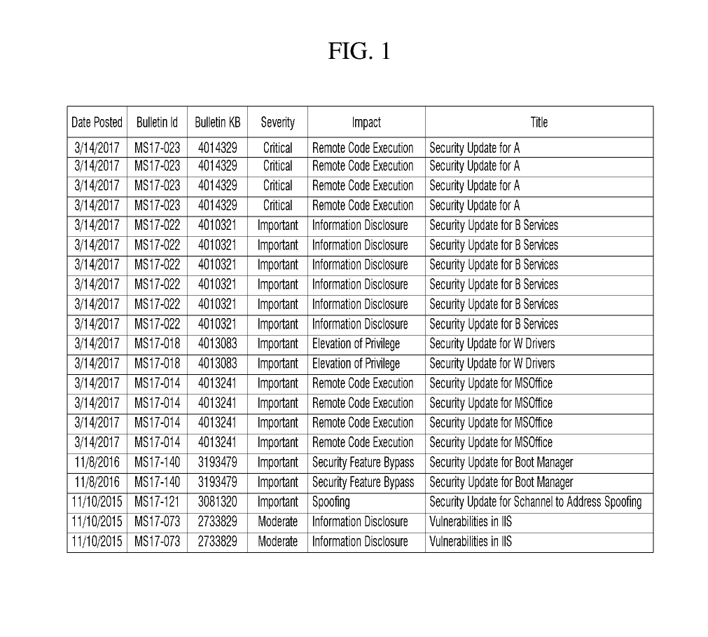

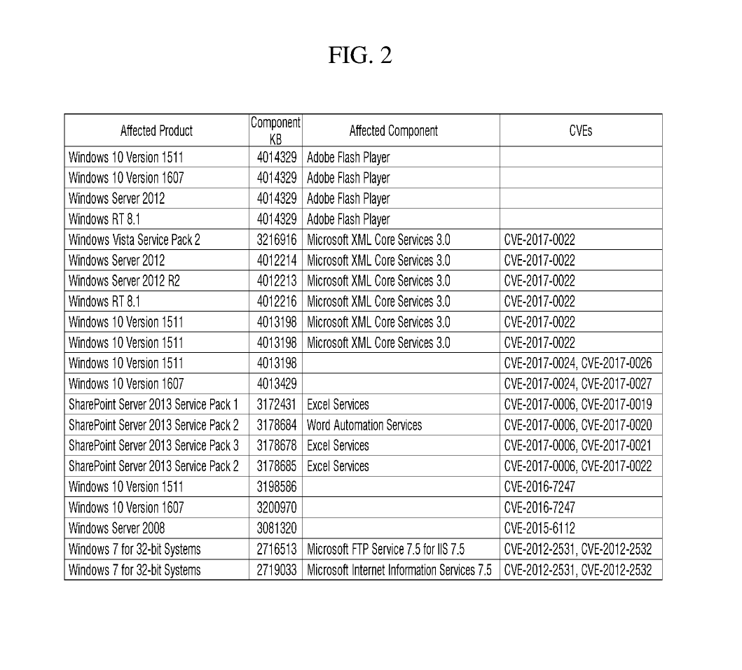

In many cases, formal vulnerability data is provided in a document file format. For example, NVD provides CVE information in an XML file format. For another example, Microsoft (tm) Corporation provides information about security vulnerabilities for a product in a spreadsheet document format. FIGS. 1 and 2 are views illustrating examples of formal vulnerability data configured in a spreadsheet document format.

According to the examples shown in FIGS. 1 and 2, the formal vulnerability data may include some of posted date (Data Posted), notified ID (Bulletin ID), severity, impact, title, affected product, component ID, affected component, and related CVE codes (CVEs). The posted date may refer to a date in which security patch information is updated. The notified ID (Bulletin ID) refers to an identifier for published security patch information. The severity refers to the degree of affecting security. The impact refers to the kind of risk, that is, the kind of vulnerability. The affected product refers to the name of a product affected by security threat. The affected component refers to the name of a component of a product affected by security threat. The component ID refers to an identifier for identifying components. The related CVE codes refer to identifiers of CVE information related to security threat.

Further, referring to FIGS. 1 and 2, a notified ID (Bulletin ID) configured in a predetermined format of ‘MS (2 digits)-(3 digits)’ is assigned to each vulnerability information.

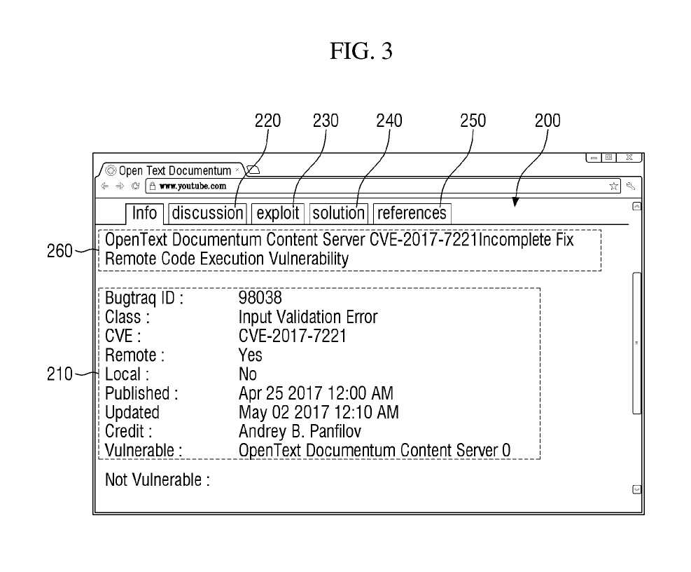

FIG. 3 is a diagram showing an example of informal vulnerability data provided by Bugtraq in the form of a web page. Referring to FIG. 3, when a user accesses a web page 200 through a browser, vulnerability information 210 included in the web page 200 may be displayed. According to an example shown in FIG. 3, the vulnerability information 210 includes a vulnerability identifier (Bugtraq ID; B-ID), the kind of vulnerability (Class), CVE-ID (CVE), remote/local information (Remote, Local), published date, and a vulnerable product (Vulnerable). The web page 200 may further include title 260, discussion 220, exploit information 230, solution 240, and reference 250, as other vulnerability information.

As shown in FIG. 3, although various vulnerability information are provided by a web page, the form of vulnerability information is changed depending on a provider of vulnerability information, and vulnerability information provided by a provider is often unstable in the format of providing vulnerability information.

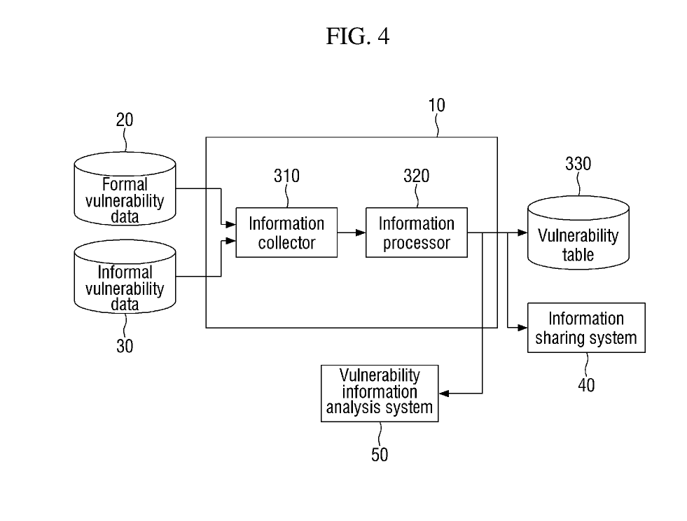

FIG. 4 is a diagram illustrating the structure of a vulnerability information collecting apparatus 10 according to an embodiment. The vulnerability information collecting apparatus 10 according to an exemplary embodiment may include an information collector 310, an information processor 320, and a storage medium 330 for storing vulnerability tables. Although it is shown in FIG. 4 that the storage medium 330 is provided outside the vulnerability information collecting apparatus 10, the storage medium 330 may be provided inside the vulnerability information collecting apparatus 10. The structure of the vulnerability information collecting apparatus 10 shown in FIG. 4 is for explaining the present invention, and may be configured differently according to an embodiment to the extent that those skilled in the art can expect. For example, the vulnerability information collecting apparatus 10 may include a processor, a storage, and a memory. Here, the memory may store an operation for performing the action of the vulnerability information collecting apparatus 10, the processor may execute the operation stored in the memory, and data such as a vulnerability table may be stored in the storage.

According to an embodiment, the information collector 310 may acquire formal vulnerability data from a formal vulnerability data source 20. According to an embodiment, the information collector 310 can acquire formal vulnerability data by downloading a vulnerability file containing formal vulnerability data from the formal vulnerability data source 20. Here, the formal vulnerability data source 20 may be a database storing a vulnerability file. Referring to http://nvd.nist.gov/, the CVE (vulnerability) information provided by NVD in the form (XML file) of formal vulnerability data. The vulnerability information collecting apparatus 10 may acquire security patch information provided in the form of a spreadsheet file or the like through https://www.microsoft.com/en-us/download/confirmation.aspx?id=36982 as formal vulnerability data. The information collector 310 may acquire informal vulnerability data from an informal vulnerability data source 30. According to an embodiment, the informal vulnerability data source 30 may be a server that provides a web page containing vulnerability information. In this case, the information collector 310 may acquire informal vulnerability data by acquiring a source code (for example, HTML code) of a web page. Here, the information collector 310 may collect the source code of the web page stored in a predetermined uniform resource locator (URL). For example, referring to http://vuldb.com/, the vulnerability information posted on a web page in VulDB is an example of informal vulnerability data. For another example, even at http://www.securityfocus.com/bid/, vulnerability information is posted through a web page. Further, informal vulnerability data may also be acquired from security patch information. Referring to http://iptime.com/iptime/?page_id=126, vulnerability information such as firmware version and security warning for a product provided by an internet device manufacturer, IP Time, is posted on a web page. Or, referring to http://netiskorea.com/atboard.php?grp1=support&grp2=download, patch information provided by Netis, another internet device provider, is posted on a web page. According to an embodiment, the information collector 310 may be configured to include a network interface for transmitting and receiving data.

Further, according to an embodiment, the information processor 320 may classify the formal vulnerability data and informal vulnerability data acquired by the information collector 310. That is, since the formal vulnerability data and the informal vulnerability data include various vulnerability information such as an identifier, the kind of vulnerability, a title, a reference, and a product name, the information processor 320 may determine what kind of information the acquired vulnerability data contains.

According to an embodiment in which formal vulnerability data is acquired through a vulnerability file, the information processor 320 may classify formal vulnerability data by performing file parsing for a vulnerability file. Further, according to an embodiment in which informal vulnerability data included in a web page is received, the information processor 320 may classify informal vulnerability data by performing a web language (for example, HTML) parsing for the source code of a web page. The information processor 320 can determine the field of a vulnerability table in which formal vulnerability data or informal vulnerability data will be stored according to the classification result.

In addition, the information processor 320 can formalize informal vulnerability data by extracting information to be stored in a predetermined field of a vulnerability table from the informal vulnerability data and combining the extracted information in a predetermined form for the field to be stored. For example, in the case of information to be stored in a vulnerability identifier filed of a vulnerability table, the information processor 320 can formalize the informal vulnerability data for the vulnerability identifier by configuring information in the form of a combination of codes indicating the source of vulnerability information numbers sequentially or arbitrarily assigned to the vulnerability information. Here, the information processor 320 can determine the source of vulnerability information depending on URL.

The information processor 320 may store the formal vulnerability data and the formalized informal vulnerability data in a field of the vulnerability table stored in the storage medium 330 according to the classification result. For example, when it is determined that the vulnerability data is a product name, the information processor 320 may store the vulnerability data in the product name field of the vulnerability table. Therefore, the vulnerability table can classify and store vulnerability information in a vulnerability identifier field, a title field, an overview field, a vulnerable product name field, a vulnerability score field, or a release field.

According to an embodiment, the vulnerability information collecting apparatus 10 may provide a vulnerability table to an information sharing system 40. The vulnerability information collecting apparatus 10 provides the vulnerability information table structured by vulnerability information to the information sharing system 40, so that the information sharing system 40 can integrally share the vulnerability information included in the formal vulnerability data and the vulnerability data.

According to another embodiment, the vulnerability information collecting apparatus 10 may provide the vulnerability table to a vulnerability information analysis system 50. The vulnerability information analysis system 50 may integrally analyze the formal vulnerability data and the informal vulnerability data using the vulnerability table.

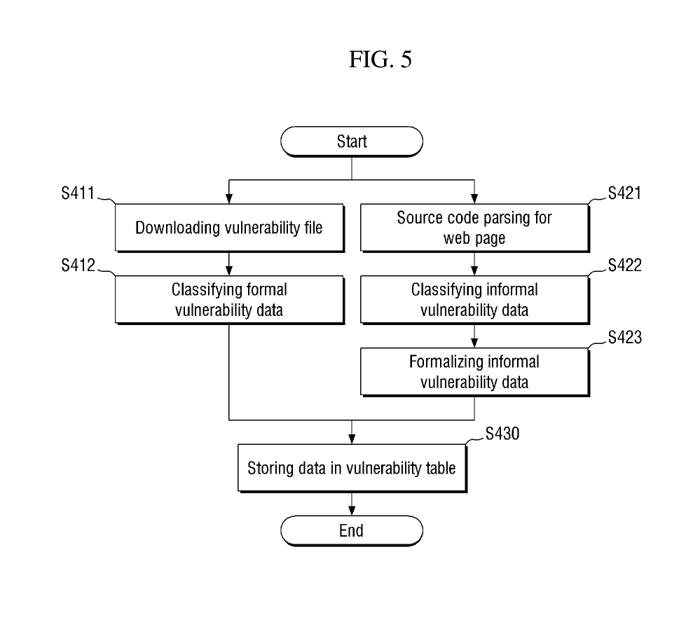

FIG. 5 is a diagram illustrating a process of collecting vulnerability information using the vulnerability information collecting apparatus 10 according to an embodiment.

First, the vulnerability information collecting apparatus 10 may download a vulnerability file including formal vulnerability data (S411). Here, the formal vulnerability data may include vulnerability information configured in a predetermined format. Thereafter, the vulnerability information collecting apparatus 10 may classify the downloaded formal vulnerability data (S412). The vulnerability information collecting apparatus 10 can perform file parsing for the vulnerability file in or der to classify the formal vulnerability data. That is, the vulnerability information collecting apparatus 10 may determine what type of vulnerability information is included in the vulnerability data by analyzing the syntax included in the vulnerability file.

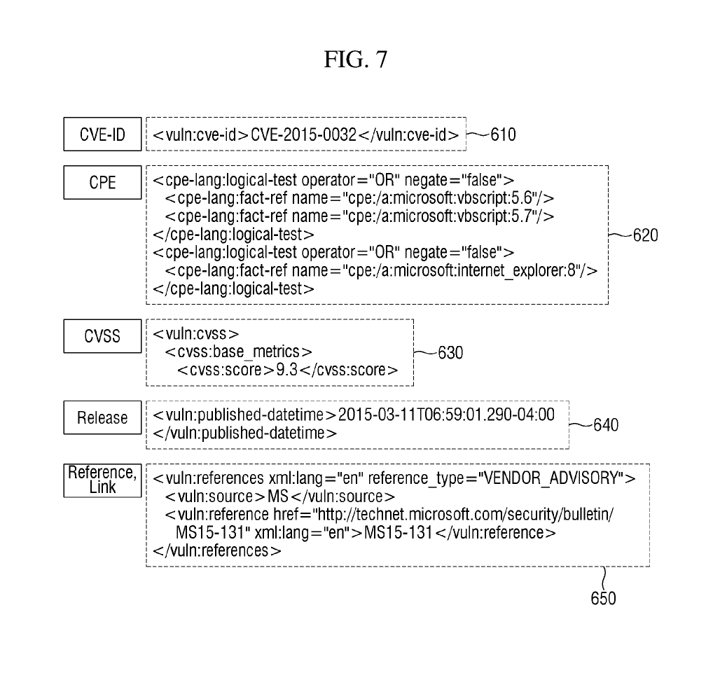

For example, the vulnerability information collecting apparatus 10 may classify formal vulnerability data based on the syntax around vulnerability information. An example in which the vulnerability information collecting apparatus 10 classifies formal vulnerability data based on the syntax around vulnerability information will be described with reference to FIG. 7. The formal vulnerability data according to this example may include a syntax 610 including a vulnerability identifier, a syntax 620 including a vulnerable product name, a syntax 630 including CVSS information, a syntax 640 including a release date, or a syntax 650 including reference information. The syntax 610 includes CVE-2015-0032 which is a vulnerability identifier recorded in the form of a CVE-ID. The syntax 620 includes cpe:/a: microsoft: vbscript: 5.6, which is a product name recorded in the form of CPE. The syntax 630 includes a vulnerability score of 9.3. The syntax 640 includes a release date Mar. 11, 2015. The syntax 650 includes a URL, which is reference link information, and a reference vulnerability information identifier. The vulnerability identifier according to this example may be configured as a CVE-ID for identifying CVE. The vulnerability information collecting apparatus 10 may determine that the syntax ‘CVE-2015-0032’ located between ‘<vuln: cve-id>’ and ‘</ vuln: cve-id>’ is a vulnerability identifier. When the vulnerability data is formal vulnerability data, since the vulnerability identifier CVE-ID is recorded in a predetermined CVE-ID format between ‘<vuln: cve-id>’ and ‘</vuln: cve-id>’, the vulnerability information collecting apparatus 10 may classify the vulnerability information by parsing the location of a specific syntax. Similarly, the vulnerability information collecting apparatus 10 may classify cpe:/a:microsoft-vbscript:5.6, which is data located between <cpt-lang: fact-ref name=“to”/>in the syntax 620, as a product name information. The vulnerability information collecting apparatus 10 may classify 9.3, which is located between <cvss:score>and </cvss:score>in the syntax 630, as a vulnerability score. The vulnerability information collecting apparatus 10 may classify Mar. 11, 2015, which is located after <vuln: published-datetime>in the syntax 640, as a release data. The vulnerability information collecting apparatus 10 may classify http://technet.micro soft.com/security/bulletin/MS15-131, which is located after <vulb:reference href=>in the syntax 650, as reference information.

In addition, the vulnerability information collecting apparatus 10 may acquire a source code for a web page including informal vulnerability data, and may perform web language parsing (for example, HTML parsing) for the acquired source code (S421). According to an embodiment, the vulnerability information collecting apparatus 10 may acquire a source code by crawling a web page according to a predetermined URL. The vulnerability information collecting apparatus 10 may classify the informal vulnerability data by performing web language parsing for the source code (S422). Thereafter, the vulnerability information collecting apparatus 10 may formalize the informal vulnerability data based on the classification result (S423).

According to an embodiment, the vulnerability information collecting apparatus 10 may input the source code into a text classification model in order to classify the vulnerability data in step S422. Here, the text classification model refers to a model for classifying input text based on a machine learning algorithm (for example, Support Vector Machine (SVM)). According to an embodiment, the vulnerability information collecting apparatus 10 may generate a text classification model by learning formal vulnerability data. For example, since the CVE information provided by NVD includes an overview of vulnerability and information related to vulnerability, the vulnerability information collecting apparatus 10 may generate a text classification model by performing a training based on the CVE information. That is, in step S422, the vulnerability information collecting apparatus 10 may further perform a step of extracting features from the formal vulnerability data and a step of generating a machine learning-based text classification model according to the extracted features. The vulnerability information collecting apparatus 10 may classify the informal vulnerability data based on the output of the text classification model.

According to another embodiment, the vulnerability information collecting apparatus 10 may extract a text including information related to vulnerability from a web page, and may also extract informal vulnerability data including a vulnerability identification number (for example, CVE-ID), the kind of vulnerability, product name information (for example, CPE value), and the like from the extracted text. For example, the vulnerability information collecting apparatus 10 may capture a screen displayed through a web page, and extract a text through image recognition of the captured screen. The vulnerability information collecting apparatus 10 may formalize the informal vulnerability data extracted from the acquired text and store the vulnerability information in the vulnerability table. In addition, the vulnerability information collecting apparatus 10 may include a hardware processor, a storage for storing the vulnerability table, and a memory for storing a plurality of operations executed by the processor. Here, the plurality of operations refers to operations for performing the action of the vulnerability information collecting apparatus 10.

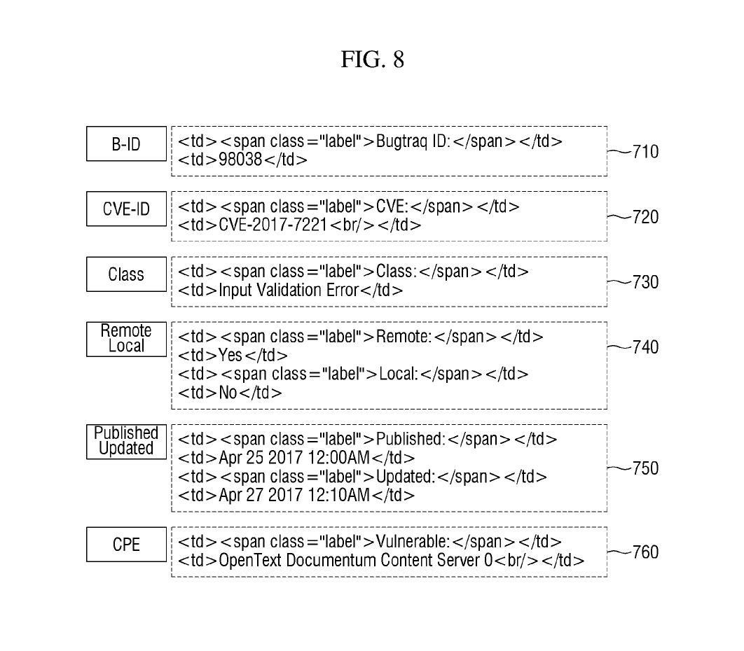

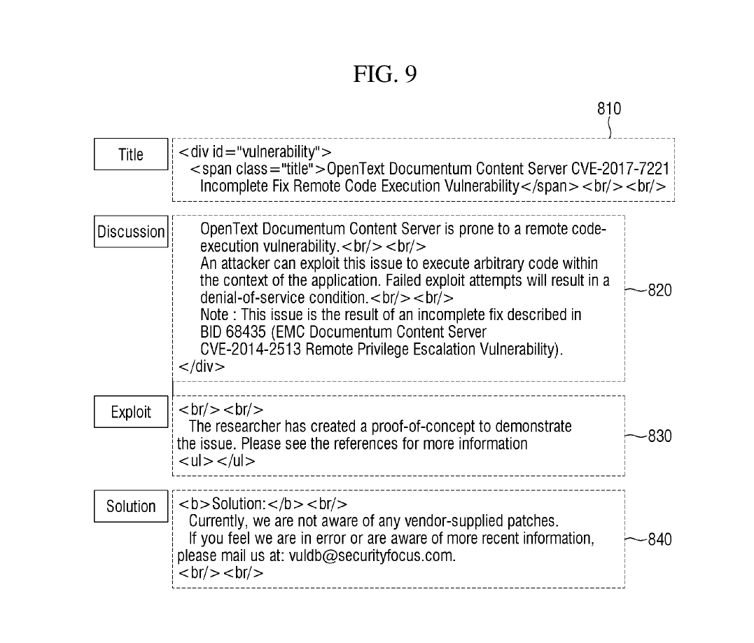

Hereinafter, specific embodiments of steps S422 and S423 will be described with reference to examples of informal vulnerability data shown in FIGS. 8 and 9. According to an embodiment, when the vulnerability information collecting apparatus 10 includes an identifier assigned to the informal vulnerability data, such as the syntax 710, the vulnerability information collecting apparatus 10 may classify the corresponding identifier as a vulnerability identifier. With respect to the syntax 710 of FIG. 8, in step S422, the vulnerability information collecting apparatus 10 may classify 98038 described after the Bugtraq ID as a vulnerability identifier. Thereafter, in step S423, the vulnerability information collecting apparatus 10 may formalize a vulnerability identifier classified from the informal vulnerability data by combining the vulnerability identifier with a vulnerability data source identification code. For example, it may be classified in the form of ‘(vulnerability data source identification code)-(vulnerability identifier)’. The vulnerability data source identification code may be a predefined value for the source providing the vulnerability data. That is, according to the example shown in FIG. 8, the formalized vulnerability identifier may be ‘B-98038’. Further, the vulnerability information collecting apparatus 10 may classify the CVE-ID when the information configured in a CVE-ID format is received from the syntax 720.

In the syntax 730, ‘Input Validation Error’, which is information about the kind of the vulnerability, is included. According to an embodiment, the vulnerability information collecting apparatus 10 may classify ‘Input Validation Error’ as the kind of vulnerability by inputting the syntax 730 into the text classification model. Here, the vulnerability information collecting apparatus 10 may generate a text classification model so as to output a vulnerability classification code corresponding to informal vulnerability data classified as information about the kind of vulnerability. For this purpose, the vulnerability information collecting apparatus 10 may extract a vulnerability summary text and a vulnerability classification code (CWE) from the formal vulnerability data. The vulnerability information collecting apparatus 10 may extract features from the vulnerability summary text, and may generate a text classification model such that the vulnerability classification code corresponding to vulnerability overview is output when a text having the extracted characteristics is input to the text classification model.

The vulnerability information collecting apparatus 10 may classify ‘Yes’ or ‘No’ located around ‘Remote’ and ‘Local’ in the syntax 740 as remote/local information. The vulnerability information collecting apparatus 10 may search keywords having a public meaning such as published, released and undated included in the syntax 750, and classify the information located around the keywords as release information.

The vulnerability information collecting apparatus 10 may collect vulnerability information by setting a position within a web page from which information is to be extracted and extracting a text displayed at the set position. For example, when a manufacturer, a product name, a product version, and the like are displayed at a fixed position such as a web page title or an upper end/lower end of a web page, the vulnerability information collecting apparatus 10 acquires information displayed at each position by setting its position in advance.

The vulnerability information collecting apparatus 10 may perform keyword analysis by setting a specific word with respect to text information included in a web page, and may classify the specific word as information of ‘Yes’ or ‘No’ when this specific word is searched.

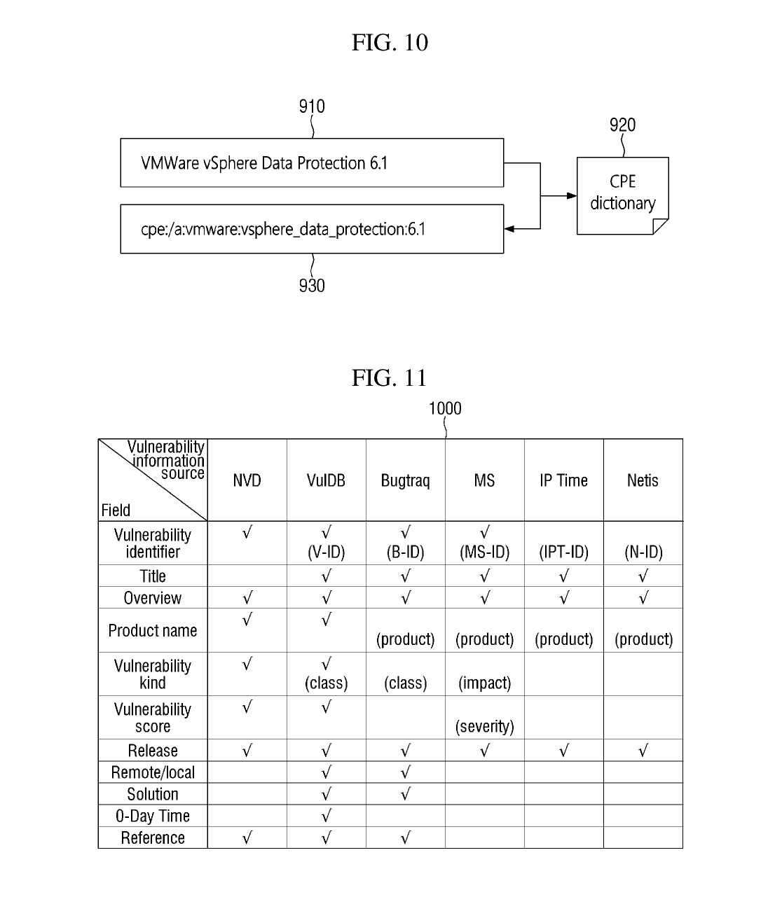

The vulnerability information collecting apparatus 10 may classify ‘Open Text Document Content Server 0’ as product name information from the syntax 760. According to an embodiment, the vulnerability information collecting apparatus 10 may convert the information classified as the product name into a CPE format in step 5422. The vulnerability information collecting apparatus 10 may search the previously generated CPE value by using the information about a manufacturer, a product name, a product version or the like. The vulnerability information collecting apparatus 10 may generate a new CPE value by combining related information. Referring to FIG. 10, there is shown a concept of a method for converting a product name into a CPE format using the vulnerability information collecting apparatus 10 according to an embodiment. The vulnerability information collecting apparatus 10 according to an embodiment may extract a keyword from the extracted product name 910, and may search a CPE value matching the keyword from a CPE dictionary 920. The vulnerability information collecting apparatus 10 may acquire a product name 930 converted from the CPE value retrieved from the CPE dictionary 920 into a CPE format.

The vulnerability information collecting apparatus 10 may generate a CPE tree using the CPE dictionary in order to convert the product name into the CPE format based on the CPE dictionary 920. According to an embodiment, the CPE tree may have six levels.

In the CPE tree having a plurality of levels and a plurality of nodes, (i) the node corresponding to the first level includes manufacturer (vendor) information, (ii) the node corresponding to the second level includes product name information, (iii) the node corresponding to the third level includes product version information, (iv) the node corresponding to the fourth level includes update information, (v) the node corresponding to the fifth level includes edition information, and (vi) the node corresponding to the sixth level includes product language information.

The generated CPE tree may include at least three levels of the first level to the sixth level. The information of the node corresponding to the first level and the information of the node corresponding to the second level may be the same as each other. That is, the product name may be the same as the manufacturer (vendor).

The CPE tree includes at least one of a parent node, a child node, and a sibling node. The parent node and the child node are connected with each other. A node corresponding to a higher level among a plurality of levels corresponds to a parent node, a node corresponding to a lower level among the plurality of levels corresponds to a parent node, and a node corresponding to the same level among the plurality of levels corresponds to a sibling node. If an intermediate level is omitted from the plurality of levels, the node corresponding to the upper level node of the omitted intermediate level and the node corresponding to the lower level of the omitted intermediate level are connected with each other.

The vulnerability information collecting apparatus 10 generates a plurality of levels by separating the character string of the CPE dictionary on the basis of the character ‘:’. The vulnerability information collecting apparatus 10 separates the character string on the basis of the character ‘˜’ at the fifth level of the CPE dictionary.

The vulnerability information collecting apparatus 10 combines the keywords contained in the product name information among the keywords of the CPE tree and converts the CPE tree into one or more CPEs conforming to the format of the CPE dictionary.

In addition, the vulnerability information collecting apparatus 10 may search the CPE value corresponding to the product name converted in a CPE format from the formal vulnerability data. When the CPE value exists in the formal vulnerability data, the vulnerability information collecting apparatus 10 may search CVE information corresponding to the CPE value. The vulnerability information collecting apparatus 10 may store the discovered CVE information in the vulnerability table. For example, the CVE information provided by NVD includes the CPE value and CWE information for the corresponding CVE. Accordingly, when the CWE information does not exist in the informal vulnerability data, the vulnerability information collecting apparatus 10 may acquire vulnerability information on the basis of the CPE value from the formal vulnerability data and store the acquired vulnerability information in the vulnerability table.

The vulnerability information collecting apparatus 10 may classifies information included in the title from the syntax 810, may classify information included in the overview information from the syntax 820, may classify information included in the utilization information from the syntax 830, and may classify the information included in the solution from the syntax 840. However, the present invention is not limited thereto.

In addition, the vulnerability information collecting apparatus 10 according to an embodiment may extract a vulnerability value expressed in digits and a vulnerability vector expressed in matrix. The vulnerability information collecting apparatus 10 may acquire formal vulnerability information by combining the vulnerability value and the vulnerability vector.

Referring to FIG. 5 again, in step S430, the vulnerability information collecting apparatus 10 may store formal vulnerability data and informal vulnerability data in the field of the vulnerability table based on the classification result. That is, the vulnerability information collecting apparatus 10 may store the vulnerability data classified as product name information in the vulnerable product name field, may store the vulnerability data classified as vulnerability information in the vulnerability score field, may store the vulnerability classification code in the vulnerability kind field, may store the information classified as a vulnerability identifier in the vulnerability identifier field, may store the information classified as a vulnerability overview in the vulnerability overview field, and may store the vulnerability data classified as a title in the title field. If the formal vulnerability data includes CVE-ID, CPE, and CWE, the CVE-ID may be stored in the vulnerability identifier field, the CPE may be stored in the vulnerable product name field, and the CWE may be stored in the vulnerability kind field. Further, according to an embodiment, the vulnerability information collecting apparatus 10 may generate a title from the vulnerability data, and store the generated title in the title field of the vulnerability table. For example, the vulnerability information collecting apparatus 10 may extract a manufacturer name, a product name, a version, and a vulnerability classification from the vulnerability data. Then, the vulnerability information collecting apparatus 10 may generate a title in the form of ‘manufacturer name, product name, version, vulnerability classification’ by combining the extracted information. The vulnerability information collecting apparatus may store the newly generated title in the title field of the vulnerability table.

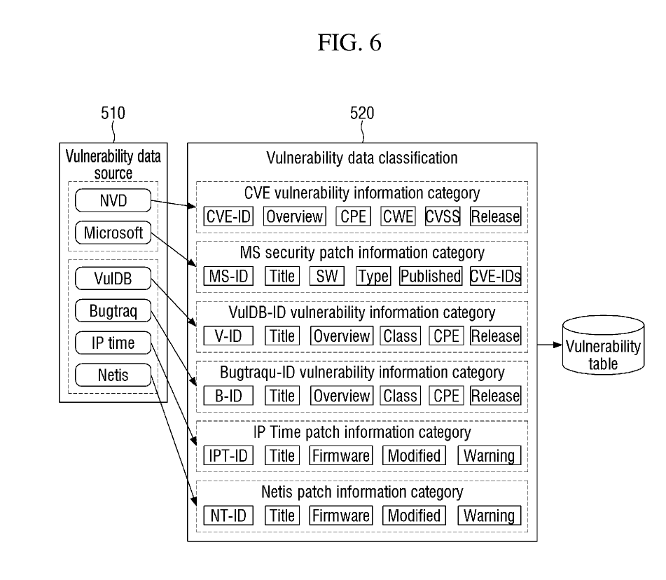

FIG. 6 is a diagram illustrating a concept of a method of classifying vulnerability data for each vulnerability data source according to an embodiment.

The vulnerability information collecting apparatus 10 may acquire vulnerability data from various vulnerability data sources 510. The vulnerability information collecting apparatus 10 may classify vulnerability data into formal vulnerability data and informal vulnerability data depending on which vulnerability data source the acquired vulnerability data was collected from. In addition, the vulnerability information collecting apparatus 10 may classify vulnerability data according to a predetermined vulnerability data classification 520.

The formal vulnerability data may be stored in each field of the vulnerability table (stored in the storage medium 330) corresponding to the classification result. The informal vulnerability data may be stored in each field of the vulnerability table through a process that is formalized based on the classification result.

For example, referring to FIG. 6, the CVE vulnerability information provided by the NVD may be classified into categories such as CVE-ID, Overview, CPE, CWE, CVSS, and Release. Here, the information classified as the CVE-ID may be stored in the vulnerability identifier field of the vulnerability table. The information classified as the Overview may be stored in the overview field. The CVSS may be stored in the vulnerability score field. The information classified as the Release may be stored in the release filed. Similarly to this, MS security patch information, which is formal vulnerability data, may also be stored in a field corresponding to an item into which each information is classified.

Further, vulnerability information provided by VulDB, vulnerability information provided by Bugtraq, and patch information provided by an internet-connected device manufacturer IP Time or Netis are classified according to each category, and then may be stored in the field of the vulnerability table corresponding to the category via a formalization step.

FIG. 11 is a view showing vulnerability information stored in a field of the vulnerability table 1000 for each vulnerability data source according to an embodiment.

Referring to FIG. 11, the CVE information included in the formal vulnerability data provided from NVD may be classified and stored in the vulnerability identifier field, overview field, product name field, vulnerability kind field, vulnerability score field, release field and reference field of the vulnerability table 1000. The informal vulnerability information provided from VulDB may be classified and stored in a vulnerability identifier field stored in the form of B-ID, a title field, an overview field, a product name field, a vulnerability score field, a release field, a remote/local field, a solution field, an 0-Day Time field, and a reference field respectively. The informal vulnerability information provided from Bugtrq may be classified and stored in a vulnerability identifier field stored in the form of B-ID, a title field, an overview field, a product name field, a vulnerability score field, a release field, a remote/local field, a solution field, an 0-Day Time field, and a reference field respectively. The informal vulnerability information provided from MS (Microsoft) Corporation may be classified and stored in a vulnerability identifier field stored in the form of MS-ID, a title field, an overview field, a product name field in which a product item of formal vulnerability data is stored, a vulnerability kind field in which an impact item is stored, a vulnerability score field in which a severity item is stored, and a release field, respectively. The informal vulnerability information provided from IP Time Corporation may be classified and stored in a vulnerability identifier field stored in the form of IPT-ID, a title field, an overview field, a product name field in which a CPE value converted from product information is stored, and a release field, respectively. The informal vulnerability information provided from Netis Corporation may be classified and stored in a vulnerability identifier field stored in the form of N-ID, a title field, an overview field, a product name field in which a CPE value converted from product information is stored, and a release field, respectively.

The methods according to the embodiments of the present invention described heretofore can be performed by the execution of a computer program implemented by a computer-readable code on a computer-readable medium. The computer-readable medium may be, for example, a removable recording medium (a CD, a DVD, a Blu-ray disc, a USB storage device, or a removable hard disc) or a fixed recording medium (a ROM, a RAM, or a computer-embedded hard disc). The computer program may be transmitted from a first computing device to a second computing device through a network, such as the internet, and installed in the second computing device, thereby enabling this computer program to be used in the second computing device. The first computing device and the second computing device all include a server device, a physical server belonging to a server pool for a cloud service, and a fixed computing device such as a desktop PC.

The computer program may be stored in a recording medium such as a DVD-ROM or a flash memory device.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of collecting vulnerability information, comprising:
downloading a vulnerability file including formal vulnerability data configured in a predetermined format from a vulnerability database;
classifying the formal vulnerability data by performing file parsing for the vulnerability file on the basis of the predetermined format;
classifying informal vulnerability data included in the source code by performing source code parsing for a source code of a web page and formalizing the informal vulnerability data on the basis of a result of the classification; and
storing the formal vulnerability data and the formalized informal vulnerability data in a field of a vulnerability table on the basis of a result of the classification.

2. The method of claim 1,
wherein the field includes a product name field,
the classifying the informal vulnerability data includes extracting a product name from a text included in the web page,
the formalizing the informal vulnerability data includes converting the product name in a CPE (Common Platform Enumeration) format, and
the storing the formal vulnerability data and the formalized informal vulnerability data includes storing the converted product name in the product name field.

3. The method of claim 2,
wherein the storing the converted product name comprises:
searching a CPE value corresponding to the product name converted in the CPE format for the formal vulnerability data;
searching common vulnerabilities and exposures (CVE) information corresponding to the CPE value from the formal vulnerability data; and
including the CVE information in the vulnerability table.

4. The method of claim 2,
wherein the converting the product name comprises:
acquiring a CPE dictionary;
generating a CPE tree having a plurality of levels and a plurality of nodes by analyzing the CPE dictionary;
searching keywords of each level of the CPE tree from the converted product name; and
outputting a CPE conforming to the format of the CPE dictionary from the CPE tree by combining keywords included in the converted product name among the keywords of the CPE tree.

5. The method of claim 1,
wherein the formalizing the informal vulnerability data includes:
extracting a vulnerability value and a vulnerability vector from the informal vulnerability data; and
converting the vulnerability value and the vulnerability vector in a common vulnerability scoring system (CVSS) format.

6. The method of claim 5,
wherein the formalized informal vulnerability data is obtained by combining the vulnerability value and the vulnerability vector.

7. The method of claim 1,
wherein the classifying the informal vulnerability data includes:
inputting the source code into a text classification model; and
acquiring the formalized informal vulnerability data on the basis of output of the text classification model.

8. The method of claim 7,
wherein the classifying the informal vulnerability data further includes:
extracting features from the formal vulnerability data; and
generating the machine learning-based text classification model on the basis of the extracted features.

9. The method of claim 8,
wherein the extracting the features includes:
extracting a vulnerability overview text and a vulnerability classification code (common weakness enumeration (CWE)); and
extracting features from the vulnerability overview text,
wherein the generating the text classification model includes generating the text classification model so as to output the vulnerability classification code when a text corresponding to the features is input into the text classification model.

10. The method of claim 1,
wherein the field includes a vulnerability identifier field, a title field, a vulnerability overview field, a vulnerable product name field, a vulnerability score field, and a vulnerability kind field.

11. The method of claim 10,
wherein the formal vulnerability data includes CVE-ID(Common Vulnerability and Exposure-Identifier), CPE, and CWE, and
the storing the formal vulnerability data includes storing the CVE-ID in the vulnerability identifier field, storing the CPE in the vulnerable product name field, and storing the CWE in the vulnerability kind field.

12. The method of claim 10,
wherein the formalizing the informal vulnerability data includes:
determining a manufacturer name, a product name, a version, and vulnerability classification from the text; and
determining a title combined with the manufacturer name, the product name, the version, and the vulnerability classification,
wherein the storing the formal vulnerability data includes storing the title in the title field of the vulnerability table.

13. An apparatus for collecting vulnerability information, comprising:
an information collector for downloading a vulnerability file including formal vulnerability data configured in a predetermined format from a vulnerability database and acquiring a source code of a web page;
an information processor for classifying the formal vulnerability data by performing file parsing for the vulnerability file, classifying informal vulnerability data included in the source code by performing source code parsing for a source code of a web page, and executing an operation of formalizing the classified informal vulnerability data in the predetermined format; and
a storage medium for storing the formal vulnerability data and the formalized informal vulnerability data in a field of a vulnerability table on the basis of a result of the classification.

14. A computer program, which is recorded in a non-transitory computer-readable medium, and which performs an operation when commands of the computer program are executed by a processor of a server, the operation comprising:
downloading a vulnerability file including formal vulnerability data configured in a predetermined format from a vulnerability database;
classifying the formal vulnerability data by performing file parsing for the vulnerability file ;
classifying informal vulnerability data included in the source code by performing source code parsing for a source code of a web page and formalizing the informal vulnerability data on the basis of a result of the classification; and
storing the formal vulnerability data and the formalized informal vulnerability data in a field of a vulnerability table on the basis of a result of the classification.
